(19) United States
(12) Patent Application Publication
(10) Pub. No.: US 2017/0320407 A1
(43) Pub. Date: Nov. 9, 2017

(54) VEHICLE SEAT

(71) Applicant: TACHI-S CO., LTD., Akishima-shi, Tokyo (JP)

(72) Inventor: Atsushi KOIKE, Tokyo (JP)

(21) Appl. No.: 15/532,998

(22) PCT Filed: Nov. 6, 2015
(86) PCT No.: PCT/JP2015/081331

§ 371 Date: Jun. 2, 2017

(30) Foreign Application Priority Data
Dec. 4, 2014 (JP) 2014-245896

(51) Int. Cl. B60N 2/22; B60N 2/02

(52) U.S. Cl. CPC B60N 2/2222; B60N 2/028

(57) ABSTRACT

Provided is a vehicle seat that has a relatively simple structure and can hold passenger's scapulae and surrounding body area even when the angle of the backrest is tilted down. A vehicle seat includes: a seat cushion forming a sitting surface of the seat; and a seat back provided at a back of the seat cushion and serving as a backrest of the seat, the seat back including: a first tippable portion provided so that an angle of the seat back to a seat frame forming a framework of the seat is adjustable; and a second tippable portion pivotally provided at an upper side of the first tippable portion, wherein when the first tippable portion is tipped toward a rear of a vehicle, the second tippable portion abuts against a projecting portion provided at the seat frame and is thus protruded from the first tippable portion.

### TECHNICAL FIELD

The present invention relates to a vehicle seat and particularly relates to angular adjustment of the backrest of the vehicle seat.

### BACKGROUND ART

Vehicle seats, such as an automobile seat, are not only required to provide various functions, including safety, holdability, and quality at getting in and out of the vehicle (ease of getting in and out of the vehicle), but also demanded to enhance passenger's comforts, including seating comfort and vibration absorbability.

Therefore, approaches have been taken toward seat production for further enhancing,in addition to the fundamental functions for vehicle seats, the comforts of passengers.

Japanese Patent Application Laid-Open No. H08-11603 (Patent Literature 1) exists as a background art in this technical field. Patent Literature 1 discloses “a powered comfort seat structure including: a seat back made up of a combination of separated upper and lower halves and formed inwardly foldably; a seat cushion provided swingably in conjunction with rocking of the seat back by being supported at a front end thereof by a front link and being connected via a rear link to the seat back; and a powered recliner allowing forward and backward rocking of the seat back under drive of a motor, wherein a fulcrum of a link is pivotally attached to an upper end of the lower half of the seat back, a lower end of the upper half of the seat back is connected and fixed to one end of the link, and the other end of the link is pivotally connected via a pivotable connecting means to a predetermined fixed member”.

It is written therein that, according to the above powered comfort seat structure, the swing of the seat cushion and the inward folding of the seat back in conjunction with the reclining of the seat back can be achieved only by the operation of a power module formed of the powered recliner, which can simplify the construction of the powered comfort seat structure and reduce the cost thereof.

### CITATION LIST

### Patent Literature

PTL 1: Japanese Patent Application Laid-Open No. H08-11603

### SUMMARY OF INVENTION

### Technical Problem

As seen from the above, vehicle seats, such as an automobile seat, have a significant challenge of producing a seat further satisfying the passenger's comforts while reducing the production cost thereof.

As for a conventional automobile seat, when, as shown in FIGS. 14A and 14B, a seat back 3 serving as a backrest is tipped backward of a passenger, a space is created between the seat back 3 and a body area of the passenger around the scapulae, which makes it difficult to sufficiently support the scapulae and surrounding body area and thus makes passenger's fatigue accumulated after a long drive.

According to the above powered comfort seat structure described in Patent Literature 1, it is possible to hold the passenger's scapulae and surrounding body area even when the backrest is tipped back. However, the seat structure is complicated and requires a drive source, such as a motor, which presents cost and maintenance problems.

In view of the above, an object of the present invention is to provide a vehicle seat that has a relatively simple structure and can hold passenger's scapulae and surrounding body area even when the angle of the backrest is tilted down.

### Solution to Problem

The present invention is directed to a vehicle seat including: a seat cushion forming a sitting surface of the seat; and a seat back provided at a back of the seat cushion and serving as a backrest of the seat, the seat back including: a first tippable portion provided so that an angle of the seat back to a seat frame forming a framework of the seat is adjustable; and a second tippable portion pivotally provided at an upper side of the first tippable portion, wherein when the first tippable portion is tipped toward a rear of a vehicle, the second tippable portion abuts against a projecting portion provided at the seat frame and is thus protruded from the first tippable portion.

The present invention is also directed to a vehicle seat including a mechanism that adjusts a backrest angle at which a seat back is tipped relative to a seat frame, the vehicle seat further including: a first tippable member located in a portion of the seat back close to a sitting surface of the seat and receiving a pad serving as a cushion member for the seat; and a second tippable member connected to a top portion of a front surface of the first tippable member and configured to be protruded or tipped from the first tippable member, the seat frame including a projecting portion abuttable against the second tippable portion, wherein when the first tippable member is tipped toward a rear of a vehicle, the second tippable member is pushed out by the projecting portion.

### Advantageous Effects of Invention

According to the present invention, even when the angle of the backrest is tilted down, the passenger's scapulae and surrounding body area can be held with a relatively simple structure, so that the accumulation of passenger's fatigue can be reduced.

Problems, structures, and effects other than those above will become apparent from the description of the following embodiments.

### BRIEF DESCRIPTION OF DRAWINGS

FIG. 1A is a view showing a general picture of a vehicle seat according to one embodiment of the present invention.

FIG. 1B is a view showing a tipping mechanism of the vehicle seat according to the one embodiment of the present invention.

FIG. 2A is a view showing a general picture of the vehicle seat according to the one embodiment of the present invention.

FIG. 2B is a view showing the tipping mechanism of the vehicle seat according to the one embodiment of the present invention.

FIG. 3A is a view showing a projecting portion of the vehicle seat according to the one embodiment of the present invention.

FIG. 3B is a view showing a partial cross-section of the projecting portion of the vehicle seat according to the one embodiment of the present invention.

FIG. 3C is a view showing a partial cross-section of the projecting portion of the vehicle seat according to the one embodiment of the present invention.

FIG. 4A is a view showing a general picture of the vehicle seat according to the one embodiment of the present invention.

FIG. 4B is a view showing the tipping mechanism of the vehicle seat according to the one embodiment of the present invention.

FIG. 5A is a view showing a general picture of the vehicle seat according to the one embodiment of the present invention.

FIG. 5B is a view showing the tipping mechanism of the vehicle seat according to the one embodiment of the present invention.

FIG. 6A is a view showing the projecting portion of the vehicle seat according to the one embodiment of the present invention.

FIG. 6B is a view showing a partial cross-section of the projecting portion of the vehicle seat according to the one embodiment of the present invention.

FIG. 6C is a view showing a partial cross-section of the projecting portion of the vehicle seat according to the one embodiment of the present invention.

FIG. 7 is a view showing operation of the tipping mechanism of the vehicle seat according to the one embodiment of the present invention.

FIG. 8A is a view showing a projecting portion of a vehicle seat according to one embodiment of the present invention.

FIG. 8B is a view showing the projecting portion of the vehicle seat according to the one embodiment of the present invention.

FIG. 9 is a view showing an inwardly foldable portion and a projecting portion of a vehicle seat according to one embodiment of the present invention.

FIG. 10A is a view showing a tipping mechanism of the vehicle seat according to the one embodiment of the present invention.

FIG. 10B is a view showing the tipping mechanism of the vehicle seat according to the one embodiment of the present invention.

FIG. 11 is a view showing the tipping mechanism of the vehicle seat according to the one embodiment of the present invention.

FIG. 12 is a view showing the tipping mechanism of the vehicle seat according to the one embodiment of the present invention.

FIG. 13A is a view showing a part of the tipping mechanism of the vehicle seat according to the one embodiment of the present invention.

FIG. 13B is a view showing a part of the tipping mechanism of the vehicle seat according to the one embodiment of the present invention.

FIG. 14A is a view for illustrating a problem of a conventional vehicle seat.

FIG. 14B is a view for illustrating the problem of the conventional vehicle seat.

### DESCRIPTION OF EMBODIMENTS

Hereinafter, a description will be given of embodiments of the present invention with reference to the drawings.

For ease of understanding of the description of the present invention, a seat cushion member (wadding), a seat cover (trim cover), and other members not directly involved in the present invention will be omitted throughout the drawings and the explanation thereof will also be omitted throughout the embodiments.

### Embodiment 1

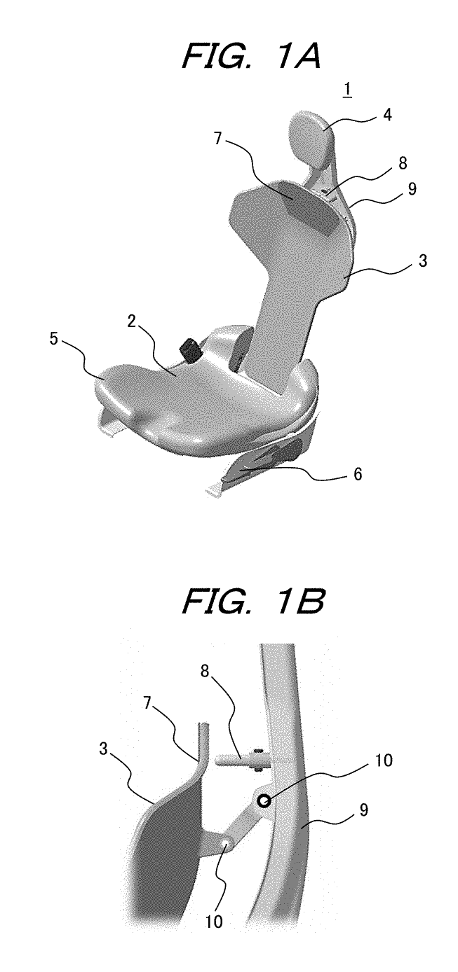

FIG. 1A shows a general picture of a vehicle seat, which is an embodiment of the present invention, for use in an automobile or the like. As shown in FIG. 1, a vehicle seat 1 in Embodiment 1 includes, as essential portions, a seat cushion 2 forming a sitting surface of the seat, a seat back 3 provided at the back of the seat cushion 2 and serving as a backrest of the seat, a head restraint 4 for protecting passenger's head and neck, and so on. Provided on both sides of the seat cushion 2 are side supports 5 serving as supports for side portions of the sitting surface. The seat back 3 can be adjusted in its angle to the seat cushion 2 by a reclining lever 6.

The seat back 3 is mounted to a seat frame 9 forming the framework of the seat so as to be supported by the seat frame 9. Furthermore, the seat back 3 is provided, at an upper portion thereof, specifically, at a location thereof corresponding to passenger's scapulae and their surrounding body area when the passenger sits on the seat, with an inwardly foldable portion 7. The inwardly foldable portion 7 is pivotally provided via an unshown hinge or the like on the seat back 3.

A projecting portion (sticking-out portion) 8 is provided on the seat back 3 side of the seat frame 9 and has a structure in which when the seat back 3 is tipped relative to the seat frame 9 toward the rear of the vehicle, the projecting portion (sticking-out portion) 8 abuts against the inwardly foldable portion 7 and the inwardly foldable portion 7 is thus pushed out of the seat back 3.

FIG. 1B shows the appearance of the inwardly foldable portion 7 and projecting portion (sticking-out portion) 8 described with reference to FIG. 1A and their surroundings. FIG. 1B is a view of an upper side of the seat back 3 of the vehicle seat 1 in FIG. 1A when viewed from the side.

As described previously, the projecting portion (sticking-out portion) 8 is provided on the seat back 3 side of the seat frame 9. Furthermore, the seat back 3 is provided so as to be supported via two movable support rods 10 by the seat frame 9. Thus, the seat back 3 can be configured so that its position relative to the seat frame 9 can be tilted toward the front and rear of the vehicle.

The inwardly foldable portion 7 is pivotally provided via a hinge or the like at an upper portion of the seat back 3.

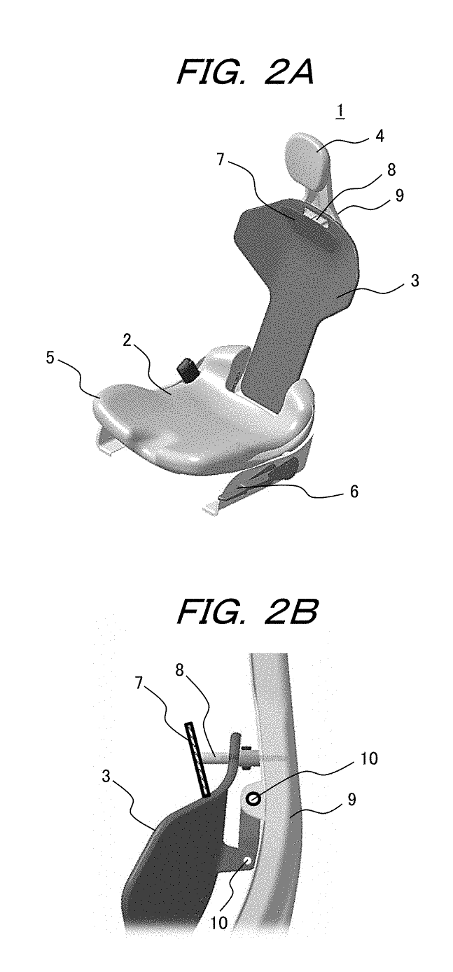

FIGS. 2A and 2B show a state where the seat back 3 is tipped relative to the seat frame 9 toward the rear of the vehicle.

When the seat back 3 is tipped relative to the seat frame 9 toward the rear of the vehicle, i.e., when, as shown in FIG. 2B, the seat back 3 supported via the plurality of movable support rods 10 by the seat frame 9 is tipped toward the rear of the vehicle, the inwardly foldable portion 7 abuts against the projecting portion (sticking-out portion) 8 provided on the seat frame 9, so that the inwardly foldable portion 7 protrudes from the seat back 3.

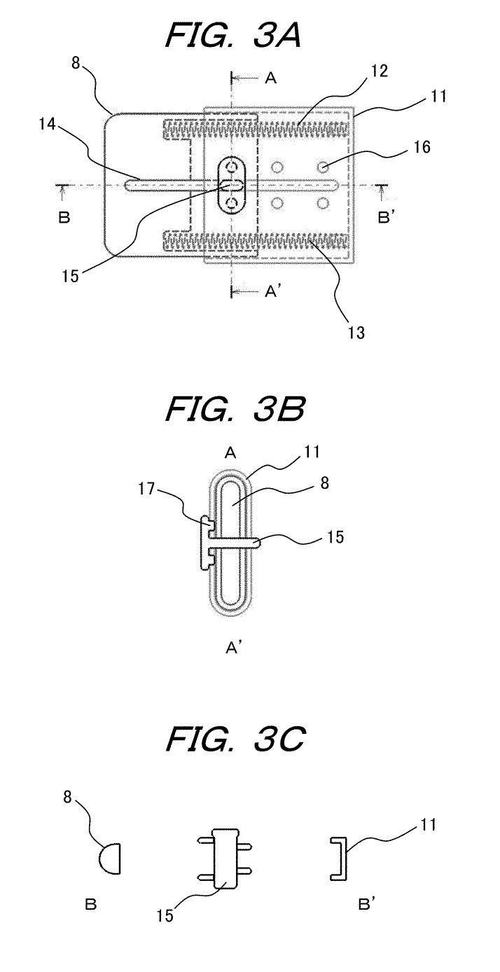

FIGS. 3A to 3C show the structure of the projecting portion (sticking-out portion) 8 provided on the seat frame 9. FIG. 3B shows a cross-section taken along the line A-A′ in FIG. 3A and FIG. 3C shows a cross-section taken along the line B-B′ in FIG. 3A.

As shown in FIG. 3A, the projecting portion (sticking-out portion) 8 has a structure in which it is mounted to the seat frame 9 via two springs, i.e., a spring A 12 and a spring B 13. The projecting portion (sticking-out portion) 8, the spring A 12, and the spring B 13 are sheathed in an outer cover 11.

A slit 14 is provided in the middle of the projecting portion (sticking-out portion) 8 and, as shown in FIG. 3B, a positioning pin A 15 is provided through the slit 14. The projecting portion (sticking-out portion) 8 is restricted in movable range by the positioning pin A 15.

As shown in FIG. 3B, the positioning pin A 15 is provided with a plurality of raised portions (juts) 17 and has a structure in which the raised portions (juts) 17 fit in a plurality of depressed portions (recesses) 16 provided in the outer cover 11.

The use of these raised portions (juts) 17 and depressed portions (recesses) 16 enables the adjustment of the amount of projection of the projecting portion (sticking-out portion) 8 from the seat frame 9. If it is needed to reduce the amount of projection of the projecting portion (sticking-out portion) 8, the raised portions (juts) 17 are fitted into the depressed portions (recesses) 16 located further to the right in FIG. 3A. On the other hand, if it is needed to increase the amount of projection of the projecting portion (sticking-out portion) 8, the raised portions (juts) 17 are fitted into the depressed portions (recesses) 16 located further to the left in FIG. 3A. In this manner, the amount of projection of the projecting portion (sticking-out portion) 8 from the seat frame 9 can be adjusted, so that when the seat back 3 is tipped toward the rear of the vehicle, the amount of protrusion of the inwardly foldable portion 7 from the seat back 3 can be adjusted.

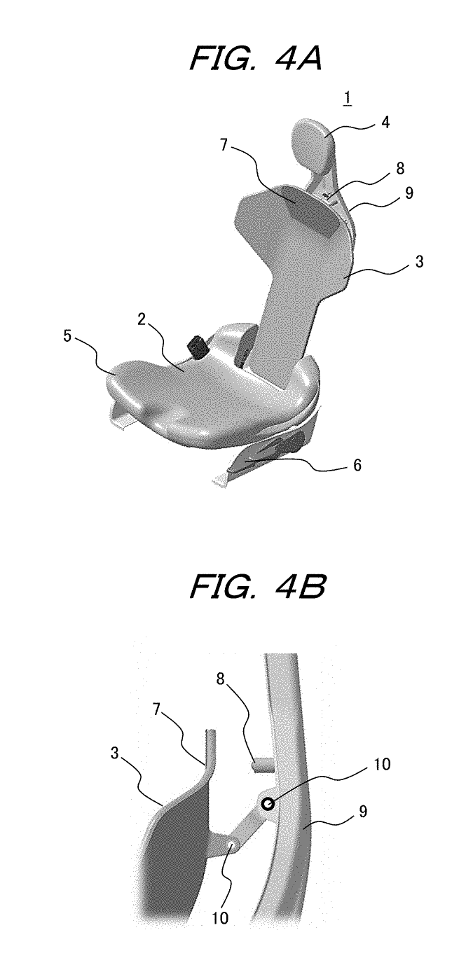

A description will be given of the case where the previously described mechanism for allowing the projecting portion (sticking-out portion) 8 to tip the inwardly foldable portion 7 is made inoperative with reference to FIGS. 4A to 6C.

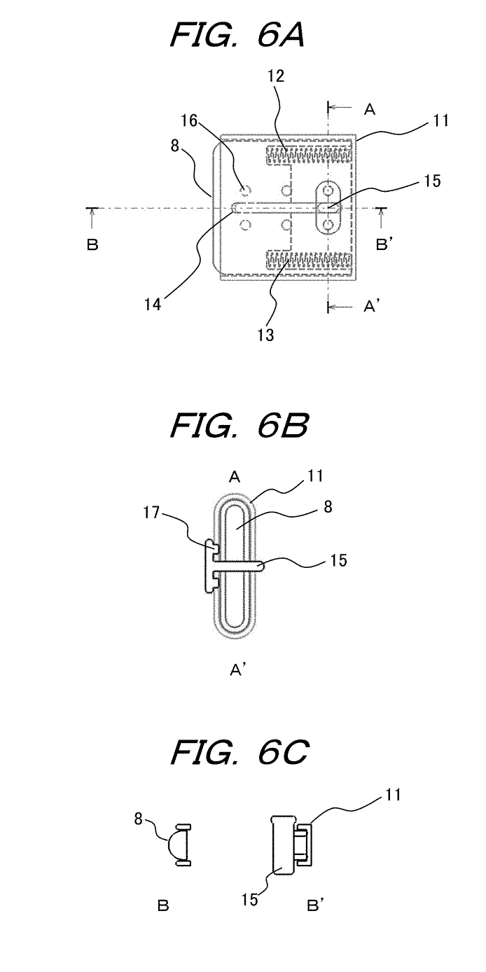

As shown in FIGS. 6A to 6C, the raised portions (juts) 17 of the positioning pin A 15 are fitted into the rightmost depressed portions (recesses) 16 in the outer cover 11, i.e., those located close to the seat frame 9. Thus, as shown in FIG. 6A, the projection of the projecting portion (sticking-out portion) 8 from the outer cover 11 can be substantially eliminated.

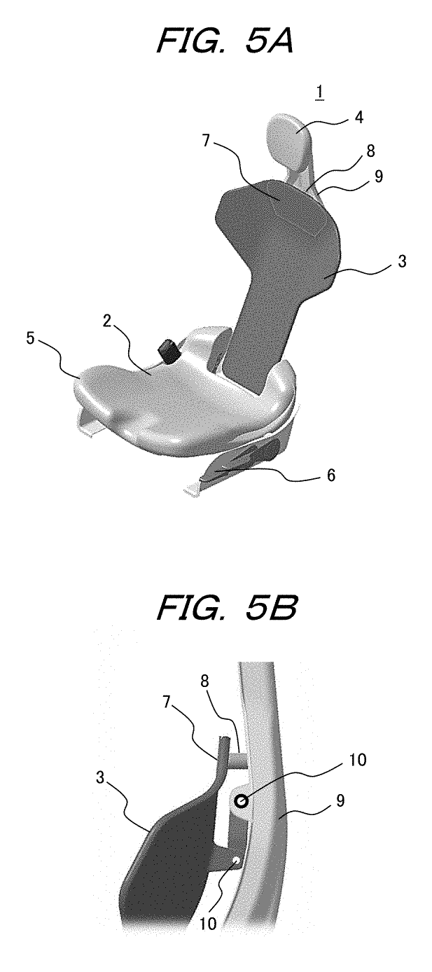

Through the above work, the distance between the inwardly foldable portion 7 and the projecting portion (sticking-out portion) 8 is increased as shown in FIGS. 4A and 4B, so that, as shown in FIGS. 5A and 5B, even when the seat back 3 is tipped toward the seat frame 9, i.e., toward the rear of the vehicle, the projecting portion (sticking-out portion) 8 can be prevented from abutting against the inwardly foldable portion 7.

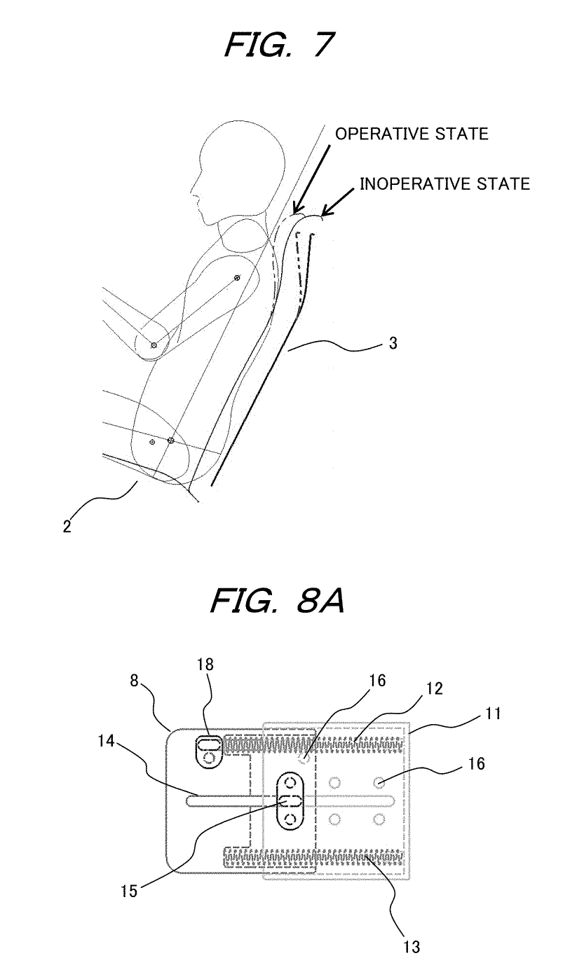

FIG. 7 shows operative and inoperative states of the mechanism, described in this embodiment, for allowing the projecting portion (sticking-out portion) 8 to tip the inwardly foldable portion 7 in the vehicle seat. When the mechanism for allowing the projecting portion (sticking-out portion) 8 to tip the inwardly foldable portion 7 is made operative as shown in FIG. 7, the tipping of the seat back 3 toward the rear of the vehicle causes the projecting portion (sticking-out portion) 8 to push out the inwardly foldable portion 7 frontward, so that the inwardly foldable portion 7 can hold the passenger's scapulae and surrounding body area.

As thus far described, according to the vehicle seat of this embodiment, even when the angle of the backrest is tilted down, the passenger's scapulae and surrounding body area can be held with a relatively simple structure, so that the accumulation of passenger's fatigue can be reduced.

Furthermore, by employing the configuration of the projecting portion (sticking-out portion) 8 shown in FIGS. 3A to 3C or the configuration thereof shown in FIGS. 6A to 6C, the adjustment of the amount of stroke, the suspension of function, and the adjustment of deflection characteristics (F-S characteristics) can be achieved with a simple structure.

Although the description in this embodiment has been given of the case where the inwardly foldable portion 7 and the projecting portion (sticking-out portion) 8 are provided separately from each other, the inwardly foldable portion 7 and the projecting portion (sticking-out portion) 8 may be provided by pivotally connecting them via a movable support rod or the like.

### Embodiment 2

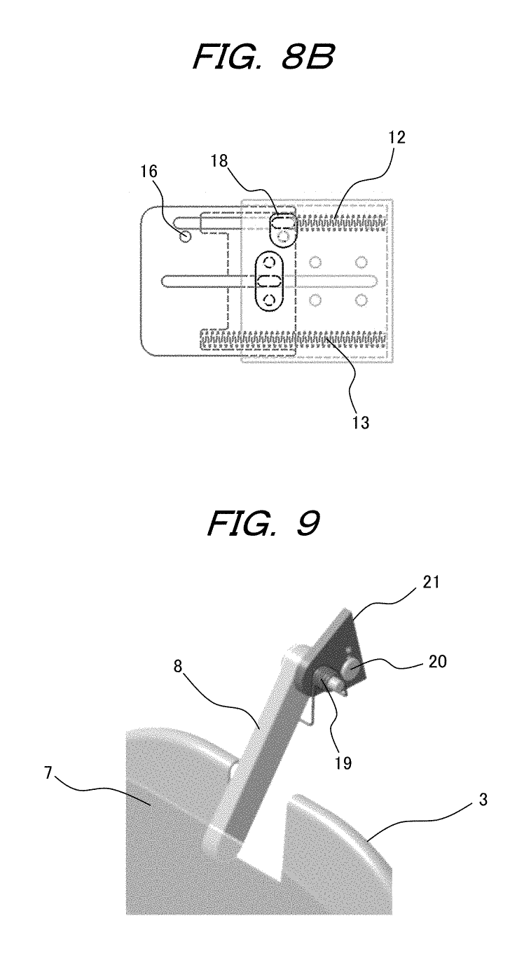

A description will be given of another embodiment of the projecting portion (sticking-out portion) 8 in the present invention with reference to FIGS. 8A and 8B. The same structural portions as in FIG. 3A or FIG. 6A are designated by the same references and detailed explanation thereof will be omitted.

The projecting portion (sticking-out portion) 8 shown in FIGS. 8A and 8B is different from the projecting portion (sticking-out portion) 8 in FIG. 3A or FIG. 6A in that one spring A 12 is provided with a stopper 18. The stopper 18 is, like the positioning pin A 15, provided at a portion thereof with a raised portion (jut) and has a structure in which the raised portion (jut) fits in one of depressed portions (recesses) 16 provided in the projecting portion (sticking-out portion) 8.

As shown in FIG. 8A, when the raised portion (jut) of the stopper 18 is fitted in the leftmost depressed portion (recess) 16, two springs for the projecting portion (sticking-out portion) 8, i.e., the spring A 12 and the spring B 13, normally function as springs to enable the resilient forces of the springs to act between the projecting portion (sticking-out portion) 8 and the outer cover 11.

In contrast, when, as shown in FIG. 8B, the raised portion (jut) of the stopper 18 is fitted in the depressed portion (recess) close to the seat frame 9, the resilient force of the spring A 12 can be disabled. This structure of the projecting portion (sticking-out portion) 8 enables the adjustment of the resiliency of the plurality of springs between the projecting portion (sticking-out portion) 8 and the outer cover 11.

Furthermore, if a number of depressed portions (recesses) fittable on the raised portion (jut) of the stopper 18 are provided, the resiliency of the plurality of springs between the projecting portion (sticking-out portion) 8 and the outer cover 11 can be more finely adjusted.

### Embodiment 3

A description will be given of still another embodiment of a mechanism for allowing the projecting portion (sticking-out portion) 8 to tip the inwardly foldable portion 7 in the present invention with reference to FIGS. 9 to 13B. The same structural portions as in the other embodiments are designated by the same references and detailed explanation thereof will be omitted.

As shown in FIG. 9, in the tipping mechanism for the inwardly foldable portion 7 in this embodiment, a lever-shaped projecting portion (sticking-out portion) 8 is provided via a spring C (coil spring) 19 at a supporting portion 21 provided on the unshown seat frame 9. Furthermore, the inwardly foldable portion 7 is pivotally provided via an unshown hinge on the seat back 3. As shown in FIG. 9, the seat back 3 is provided with a cutaway and has a structure in which the lever-shaped projecting portion (sticking-out portion) 8 can be moved forward and backward through the cutaway.

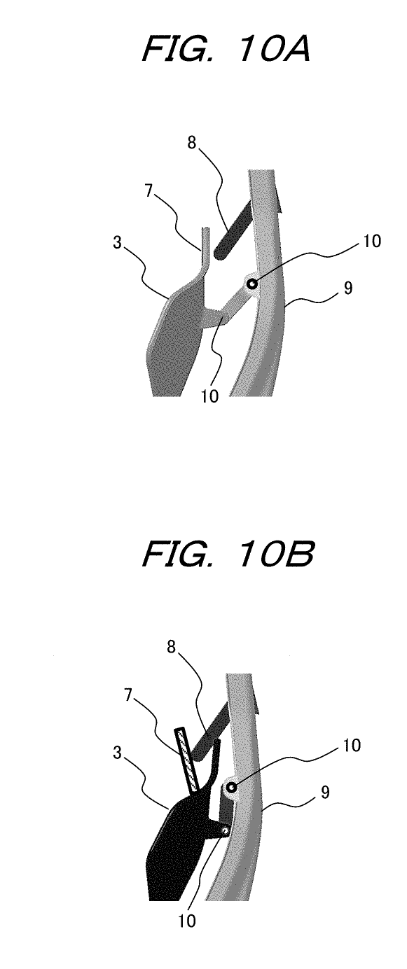

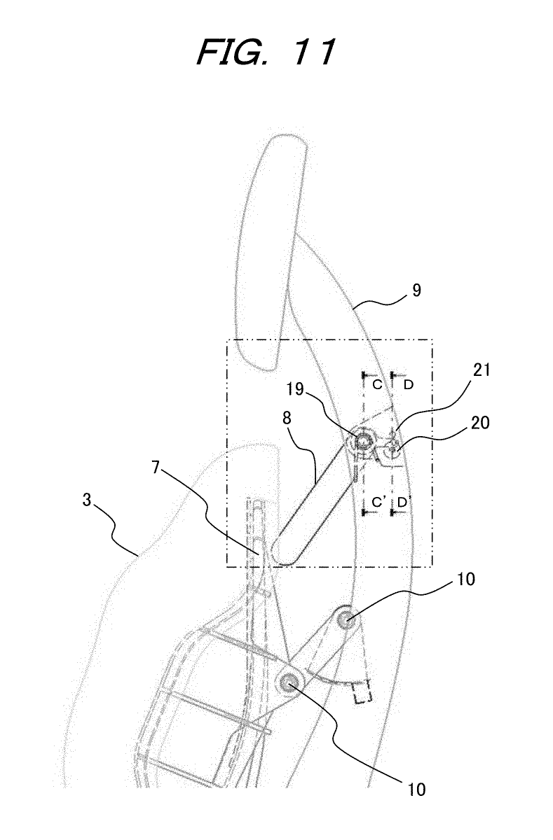

As shown in FIGS. 10A and 10B, when the seat back 3 is tipped toward the seat frame 9, i.e., toward the rear of the vehicle, the lever-shaped projecting portion (sticking-out portion) 8 provided via the spring C (coil spring) 19 at the seat frame 9 abuts against the inwardly foldable portion 7, so that the inwardly foldable portion 7 is pushed out of the seat back 3.

Furthermore, a connecting portion between the supporting portion 21 and the projecting portion (sticking-out portion) 8 is provided with a positioning pin B 20 and the resilient force of the spring C (coil spring) 19 acting on the projecting portion (sticking-out portion) 8 can be adjusted by adjusting the position of the positioning pin B 20.

FIGS. 11 to 13B show a more detailed structure of the above-described mechanism for allowing the projecting portion (sticking-out portion) 8 to tip the inwardly foldable portion 7.

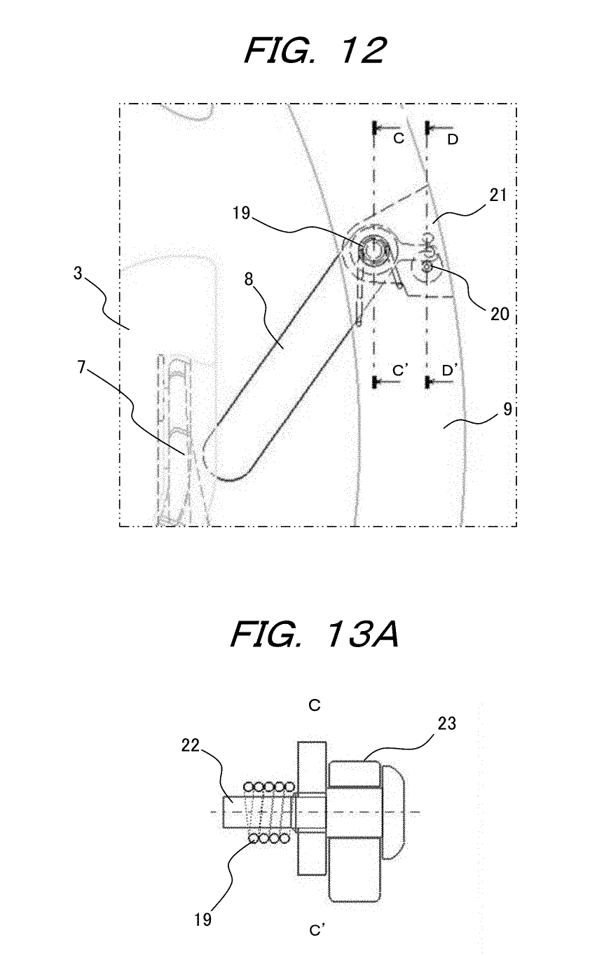

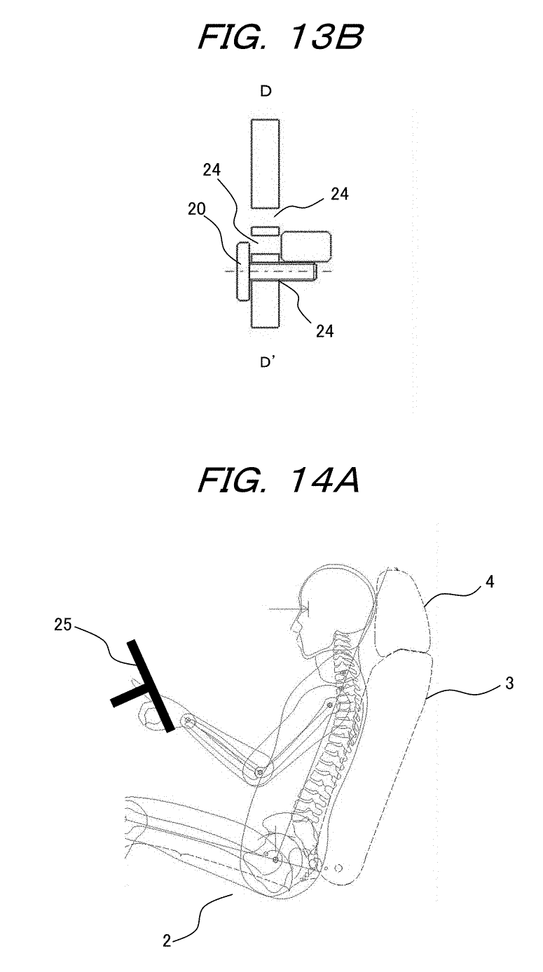

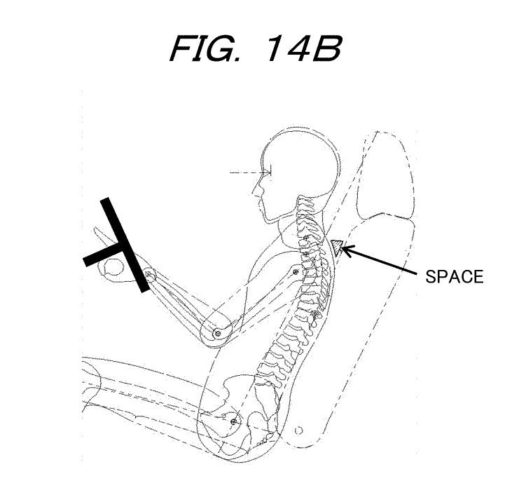

FIG. 12 is an enlarged view of the part enclosed by the broken line in FIG. 11, or shows in greater detail how the lever-shaped projecting portion (sticking-out portion) 8 is provided at the seat frame 9. Furthermore, FIG. 13A shows a cross-section taken along the line C-C′ in FIG. 12 and FIG. 13B shows a cross-section taken along the line D-D′ in FIG. 12.

As shown in FIG. 13A, the spring C (coil spring) 19 is mounted around the shank of a bolt for fastening the supporting portion 21 to the projecting portion (sticking-out portion) 8.

Furthermore, as shown in FIG. 13B, a position adjustment mechanism formed of a plurality of positioning holes 24 provided in the supporting portion 21 and the positioning pin B 20 is provided between the lever-shaped projecting portion (sticking-out portion) 8 and the supporting portion 21. As described previously, the amount of projection of the projecting portion (sticking-out portion) 8 given by the spring C (coil spring) 19 can be adjusted by adjusting the position of the positioning pin B 20.

As thus far described, according to the vehicle seat of each of the embodiments, even when the angle of the backrest is tilted down, the passenger's scapulae and surrounding body area can be held with a relatively simple structure, so that the accumulation of passenger's fatigue can be reduced.

Furthermore, by employing the configuration of the inwardly foldable portion 7 and the projecting portion (sticking-out portion) 8 in each of the embodiments, the adjustment of the amount of stroke, the suspension of function, and the adjustment of deflection characteristics (F-S characteristics) can be achieved with a simple structure.

The present invention is not limited to the above embodiments and includes various modifications. For example, the above embodiments have been merely described in detail in order to facilitate understanding of the present invention and are not necessarily limited to those including their entire structures described above. Furthermore, part of the structure of one embodiment can be replaced with part of the structure of another embodiment and the structure of one embodiment can be added to the structure of another embodiment. Moreover, in relation to part of the structure of each embodiment, another structure can be added thereto or the part of the structure can be deleted or replaced with another structure.

### REFERENCE SIGNS LIST

1 . . . vehicle seat,

2 . . . seat cushion,

3 . . . seat back,

4 . . . head restraint,

5 . . . side support,

6 . . . reclining lever,

7 . . . inwardly foldable portion,

8 . . . projecting portion (sticking-out portion),

9 . . . seat frame,

10 . . . movable support rod,

11 . . . outer cover,

12 . . . spring A,

13 . . . spring B,

14 . . . slit,

15 . . . positioning pin A,

16 . . . depressed portion (recess),

17 . . . raised portion (jut),

18 . . . stopper,

19 . . . spring C (coil spring),

20 . . . positioning pin B,

21 . . . supporting portion,

22 . . . fastening bolt,

23 . . . end of projecting portion (sticking-out portion) 8 close to supporting portion 21,

24 . . . positioning hole,

25 . . . handle.

1. A vehicle seat comprising:
a seat cushion forming a sitting surface of the seat; and
a seat back provided at a back of the seat cushion and serving as a backrest of the seat,
the seat back including:
a first tippable portion provided so that an angle of the seat back to a seat frame forming a framework of the seat is adjustable; and
a second tippable portion pivotally provided at an upper side of the first tippable portion,
wherein when the first tippable portion is tipped toward a rear of a vehicle, the second tippable portion abuts against a projecting portion provided at the seat frame and is thus protruded from the first tippable portion.

2. The vehicle seat according to claim 1, wherein the second tippable portion is pivotally connected to the projecting portion.

3. The vehicle seat according to claim 1, wherein the projecting portion is provided via at least one spring at the seat frame.

4. The vehicle seat according to claim 1, wherein
the projecting portion is provided via at least two springs at the seat frame, and
the vehicle seat further comprises a resilient force adjusting means that disables a resilient force of at least one of the at least two springs.

5. The vehicle seat according to claim 1, wherein the projecting portion comprises an amount-of-protrusion adjusting means capable of adjusting an amount of protrusion of the second tippable portion from the first tippable portion.

6. A vehicle seat including a mechanism that adjusts a backrest angle at which a seat back is tipped relative to a seat frame, the vehicle seat comprising:
a first tippable member located in a portion of the seat back close to a sitting surface of the seat and receiving a pad serving as a cushion member for the seat; and
a second tippable member connected to a top portion of a front surface of the first tippable member and configured to be protruded or tipped from the first tippable member,
the seat frame comprising a projecting portion abuttable against the second tippable portion,
wherein when the first tippable member is tipped toward a rear of a vehicle, the second tippable member is pushed out by the projecting portion.

7. The vehicle seat according to claim 6, wherein the second tippable portion is pivotally connected to the projecting portion.

8. The vehicle seat according to claim 6, wherein the projecting portion is provided via at least one spring at the seat frame.

9. The vehicle seat according to claim 6, wherein
the projecting portion is provided via at least two springs at the seat frame, and
the vehicle seat further comprises a resilient force adjusting means that disables a resilient force of at least one of the at least two springs.

10. The vehicle seat according to claim 6, wherein the projecting portion comprises an amount-of-protrusion adjusting means capable of adjusting an amount of protrusion of the second tippable portion from the first tippable portion.
